(19) United States
(12) Patent Application Publication
(10) Pub. No.: US 2006/0174129 A1
(43) Pub. Date: Aug. 3, 2006

(54) Authentication method and system for tagged items

(76) Inventors: Cyril Brignone, Mountain View, CA (US); Steven J. Simske, Fort Collins, CO (US); Jorge E. Badillo, Rincon, PR (US); Bill Serra, Montara, CA (US); Guillaume Oget, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/048,139

(22) Filed: Jan. 31, 2005

(51) Int. Cl. H04L 9/00

(52) U.S. Cl. 713/181

(57) ABSTRACT

Implementations of the present invention provide an authentication method for tagged items. The first portion of the authentication method includes determining an identifier associated with a tag for each of one or more items in a container and hashing the identifiers from the one or more items in the container creating a digest. The second portion of the authentication method is performed after the items are shipped or transferred. This second portion of the authentication method includes determining an identifier associated with a tag for each of the one or more items in a container, hashing the identifiers from the one or more items in the container to create a verification digest, determining if the verification digest matches a digest of the identifiers previously hashed and indicating that the contents of the container may have changed in response to the match determination.

### BACKGROUND OF THE INVENTION

The present invention relates to authenticating items being manufactured and shipped. A great number of products are manufactured in multiple countries around the world. Many times, the same product is manufactured in different countries to take advantage of lower labor costs and overhead in manufacturing as well as proximity to the parties using the products. Currently, the source of manufacture needs to be individually marked on each item to determine the country of origin. This is sometimes difficult or impossible if the items are small or fungible and difficult to write upon or mark. For example, it is difficult to mark pills or other drugs as they are too small and numerous to accurately mark and track. In the pharmaceutical industry, tracking manufacturers is of particular importance as the ingredients and compositions of drugs must be carefully controlled and monitored.

Even if it were possible to mark or label certain items, counterfeiters intentionally introduce many items into commerce with the intent to deceive the users of the product origin or source. These counterfeiters may create legitimate products during normal manufacturing only to then use the same factories to generate overruns in off-hours for sale in the gray market. Other unauthorized counterfeiters may attempt to pass off items as legitimate however in an attempt to save money or due to inadequate manufacturing capabilities may produce an inferior or sometimes dangerous product.

Counterfeiters are particularly interested in creating counterfeit pharmaceutical products as the profit margins are quite high and it is difficult to identify knock-offs. In the case of pills and other pharmaceuticals, counterfeiters set up business in different countries around the world and then sell the products at lower costs into the same market as the authentic or authorized products. If the chemical compositions are the same, the counterfeit products steal away profits from the companies attempting to recoup their research and development investments in developing the drug. Worse yet, counterfeiters who fail to accurately replicate a drug may induce serious illness or death to those unfortunate enough to take the ersatz medicine.

Conventional approaches to ensuring only authentic items are allowed to enter a market place are difficult to implement and prone to error. For example, many items shipped internationally on ocean freighters in standardized shipping containers are not carefully inspected as it is too time consuming and hard to police. Indeed, the profit associated with counterfeit items is so great that current penalties are not effective deterrents. Further, random inspections only capture a few of the counterfeit items and do not dissuade others from continuing this practice.

### BRIEF DESCRIPTION OF THE DRAWINGS

FIG. 1 is a schematic diagram of a system for shipping items authenticated using RFID and encryption technology in accordance with one implementation of the present invention;

FIG. 2 is a schematic diagram illustrating the logical relationship between the RFID tags associated with the items and a container holding the items in accordance with one implementation of the present invention;

FIG. 3 is a flowchart of the operations associated with hashing and encrypting RFID identifiers in accordance with one implementation of the present invention;

FIG. 4 is another flowchart illustrating the operations associated with authenticating one or more items in accordance with implementations of the present invention; and

FIG. 5 is a schematic diagram of a RFID authentication system and components used in accordance with one implementation of the present invention.

Like reference numbers and designations in the various drawings indicate like elements.

### SUMMARY OF THE INVENTION

One aspect of the present invention features an authentication method for tagged items. The first portion of the authentication method includes determining an identifier associated with a tag for each of one or more items in a container and hashing the identifiers from the one or more items in the container creating a digest. The second portion of the authentication method is performed after the items are shipped or transferred. This second portion of the authentication method includes determining an identifier associated with a tag for each of the one or more items in a container, hashing the identifiers from the one or more items in the container to create a verification digest, determining if the verification digest matches a digest of the identifiers previously hashed and indicating that the contents of the container may have changed in response to the match determination.

### DETAILED DESCRIPTION

Generally, an identifier associated with an RFID tag uniquely identifies an item and helps take inventory of a large number of items rapidly and efficiently. Implementations of the present invention hash and encrypt these identifiers to create a unique signature for one or more items in a container and ensure the items are authentic as they pass through various points of commerce. Upon delivery of the items, the recipient compares the hashed RFID identifier generated prior to shipping with a separately computed hashed RFID identifier from the one or more items stored in the container. The hashed RFID identifier generated prior to shipping can be stored in an RFID tag of the container or in a secure database. For added security and authentication, the hashed RFID identifier stored in the container RFID tag is also encrypted with a key to further prevent tampering and ensure reliable authentication.

Aspects of the present invention are advantageous in at least one or more of the following ways. An authentication method implemented in accordance with the present invention will significantly reduce attempts to ship counterfeit or otherwise unauthorized items. For example, the hashed RFID identifier can be used to indicate if even one counterfeit item is included with otherwise authentic items in a container. The hashed RFID identifier identifies a particular group of items in the container based on the particular group of RFID identifiers. Once the hashed RFID identifier is generated, counterfeiters cannot add RFID tags and counterfeited items into a container as the hashed RFID identifier will not be the same when verified by the recipient. Barring possible collisions in the hash, any attempt to add counterfeit items or remove already authorized items from the container alters the hashed RFID identifier value and can be detected.

Encrypting the hashed RFID identifier further prevents a counterfeiter from regenerating the hashed RFID with one or more counterfeit items. For example, the counterfeiter may be able to generate a hash of the RFID identifiers associated with the counterfeit items but will not be able to encrypt the resulting value without access to a key. Unless the key can be discovered, the counterfeit goods are readily intercepted upon receipt as the hashed RFID identifiers cannot be properly encrypted and/or decrypted.

Implementations of the present invention are also advantageous as they remain backward compatible with many other RFID technologies. Legacy identifiers already associated with RFID tags can be used to implement the authentication operation associated with implementations of the present invention. Only a small amount of memory on-board the RFID tag is used to store the hashed and encrypted identifier values. Rather than storing in an RFID tag, the hashed and encrypted RFID tag value can alternatively be stored in a secure database upon shipping and then referenced again when the RFID tagged items are received in their container.

Further, implementations of the present invention can be used with many other identification technologies. Instead of using RFID tags exclusively, implementations of the present invention can also work with items tagged using bar codes or a combination of bar codes and RFID tags. If items are uniquely identified using bar codes, the values represented by the bar code can also be hashed and encrypted like the identifiers provided by the RFID tag identifiers. Even if the bar codes are not entirely unique, the values represented by the bar codes can be hashed and still provide some indicia of authenticity. This further enables implementations of the present invention to be used with a combination of existing bar code and RFID tag technologies.

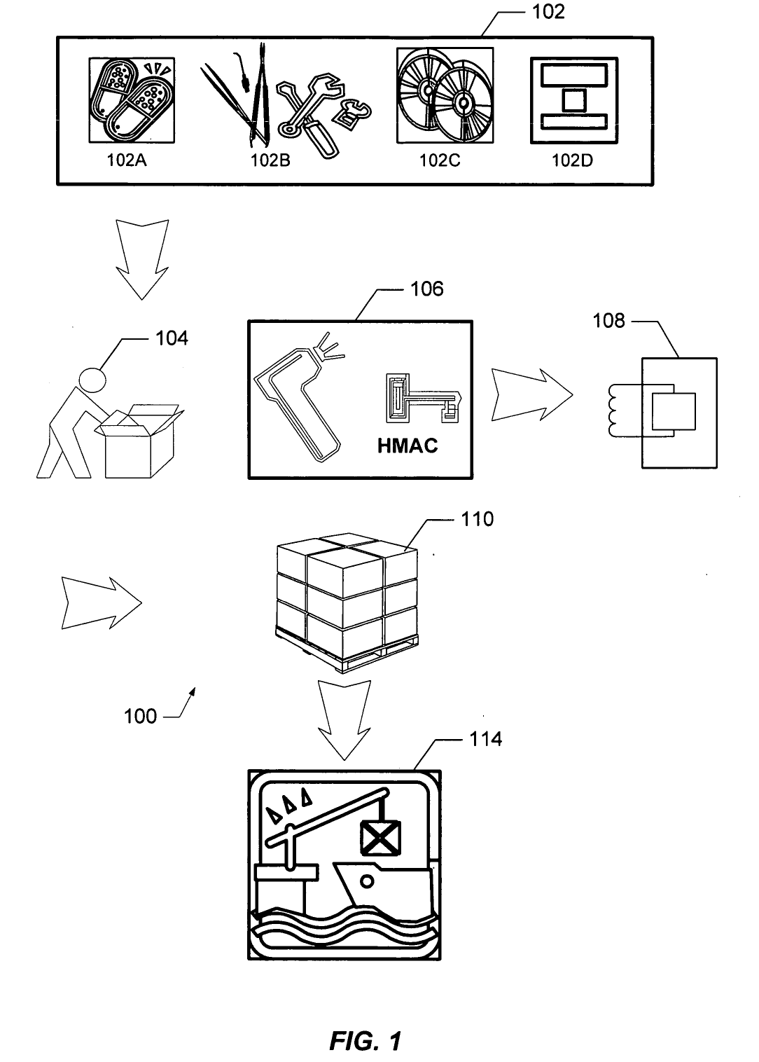

FIG. 1 is a schematic diagram of a system 100 for shipping authentic items 102 using RFID and encryption technology 106 in accordance with one implementation of the present invention. System 100 also includes a package 104, RFID and encryption technology 106, a container RFID tag 108, a container 112 for holding authentic items 102 and their packaging and a shipping method 114.

In this example, authentic items 102 represents the various items manufactured by industries associated with the production of drugs 102A, tools 102B, media 102C and devices 102D. Drugs 102A can be delivered through pills, elixirs, inhalers, injectable materials, transdermal patches and subcutaneous drug implants. Tools 102B include medical tools, automotive tools and any other tools while media 102C represents various storage devices used to hold media including compact discs (CD), digital video discs (DVD), flash memory and the electronics equipment associated with processing media stored on these media 102C. Devices 102D include smaller electronic and mechanical devices, medical devices, as well as more complex items like computers and data storage systems. While only a few classes of items are illustrated for brevity, authentic items 102 also include any other items susceptible to counterfeiting or identification using an RFID tag. For example, this could also include automobiles, sporting equipment, luxury items (i.e., purses, handbags, shoes, leather goods) and many other items as it is contemplated that aspects of the present invention could be widely used in many different industries and businesses.

In practice, authentic items 102 are typically held in some type of package 104 associated with an RFID tag. This package could be a conventional box, a medicine vial, shrink wrap or plastic material; alternatively, package 104 and RFID tag could be integral to item. For example, an RFID tag could be embedded within or on the surface of drug 102A making drug 102A both the item to be authenticated as well as a type of package 104. RFID tags can also be permanently or semi-permanently attached to authentic items 102 during manufacture or shortly thereafter using adhesive or mechanical methods (i.e., rivets, staples, prongs). In any event, an RFID tag is somehow associated with each item to be tracked either by placing the item in a package having an RFID tag or by integrating the RFID tag and packaging with the item.

Each RFID tag has an identifier that is read by an RFID tag reader/writer or other device available in RFID and encryption technology 106. As will be described later herein, identifiers associated with one or more RFID tags are combined together, hashed and encrypted using a key. For example, HMAC (hashed message authentication code) can be used in one construction for hashing and encrypting one or more identifiers gathered from the RFID tags in accordance with implementations of the present invention. The key in RFID and encryption technology 106 used for encryption can be a shared private key or can be made available to parties sending and receiving items through a public-private key sharing protocol like PGP (Pretty Good Privacy).

In one implementation, RFID reader/writer stores the hashed and encrypted identifiers into a container RFID tag 108. Each container RFID tag 108 is associated with a container 110 designed to hold one or more items and their various packages. For example, container RFID tag 108 can be permanently attached to a pallet or other container 110 used to hold many items as required by shipping method 114. In many cases, shipping method 114 involves long distances and many stops and transfers of container 110 thus allowing counterfeiters many opportunities to potentially replace one or more of authentic items 102 with counterfeit items. However, implementations of the present invention can also be used to authenticate items traveling over shorter distances and involving fewer stops and transfers of container 110.

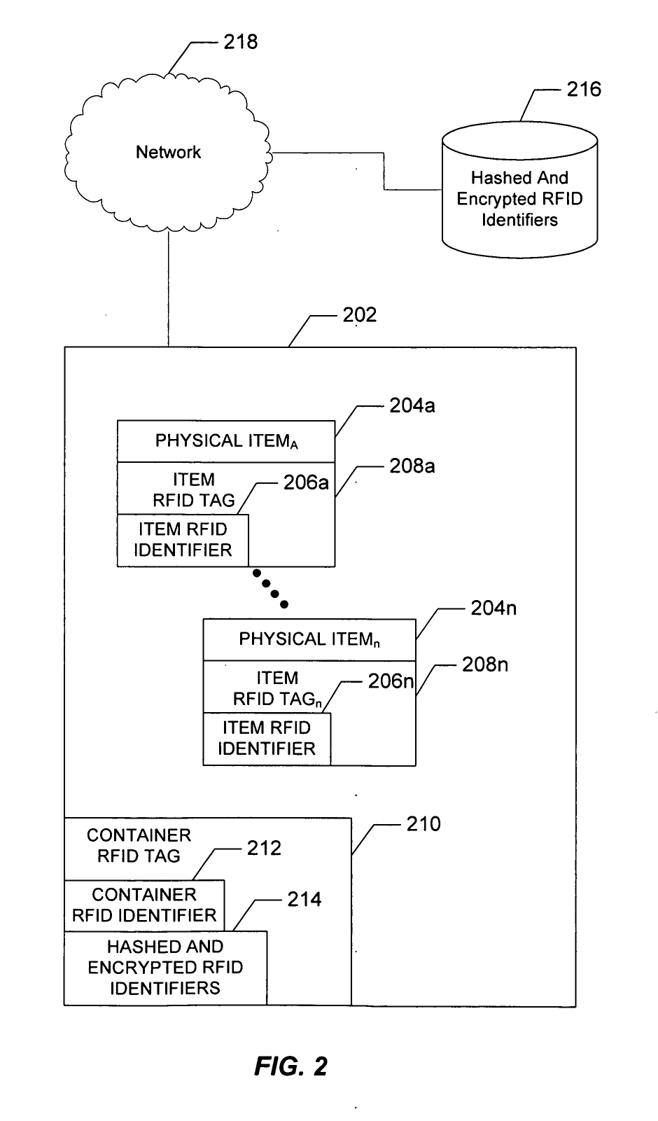

FIG. 2 is a schematic diagram illustrating the logical relationship between the RFID tags associated with the items and a container holding the items in accordance with one implementation of the present invention. In this example, a logical container 202 includes a range of physical itemₐ 204a to physical itemₙ 208n. Physical items including drugs, tools, devices or anything that can be tagged using an RFID tag.

Physical item 204a is associated with item RFID tag 208a and item RFID identifier 206A. Similarly, physical itemₙ 208 also has an RFID tagₙ 208n as well as an item RFID identifier 206n. Each physical item includes packaging that associates the RFID tag with the physical items. In general, it is expected that every item in container 202 has an RFID tag and corresponding RFID identifier associated with it in a one-to-one relationship. For brevity, many other portions of the RFID tag have been omitted from the illustration as they are well-known by those in the art.

In one implementation, each of the item identifiers are combined and hashed using a hashing function. For example, the hashing function can be based upon MD4, MD5, SHA or SHA-1 in one or more implementations of the present invention. Hashing the combination of these identifiers from the RFID tags creates a digest or summary of the identifiers that serves as an electronic signature. Unlike encryption, the hash is an operation that generates a digest of a predetermined length and does not depend on the length of the RFID identifiers. For example, hashing the RFID identifiers connected in sequence to form a longer string or combining them in an overlapping manner to form a shorter string would result in different values but the same length digest.

Hashing is also unlike encryption in that the operation is a one-way transformation. The RFID identifiers can be hashed into a digest value but the digest value cannot be used to discover the underlying RFID identifiers associated with the items in container 202. Unless there is a collision in the hash, any variation in the RFID identifiers is readily detected when the recipient of the tagged items hashes the modified RFID identifiers. Conversely, the RFID tag and item are considered authentic when the RFID identifiers produce the same digest value when computed by both the sender and receiver of the items. This feature of hashing is utilized by implementations of the present invention to detect and identify counterfeiters substituting or including counterfeit items and RFID tags in container 202.

Another implementation of the present invention not only hashes but also encrypts the digest to provide an even higher degree of authentication. The hashing and encryption operations can be performed as separate operations or together using HMAC-MD4, HMAC-MD5, HMAC-SHA, HMAC-SHA-1 or other type function. The key used to perform the encryption in any of these aforementioned operations is known by the sender and receiver but not by the counterfeiter attempting to pass-off counterfeit goods. The sender hashes the RFID identifiers and encrypts the resulting digest before sending to the receiver. Upon receipt, the receiver authenticates by independently computing the hash and comparing with the decrypted version of the transmitted digest.

In one implementation of the present invention, the sender transmits the hashed and encrypted RFID identifiers by storing in a RFID tag storage area within container RFID tag 210. The recipient or receiver of container 202 reads the hashed and encrypted identifiers 214 as part of the authentication process. Alternatively, the sender can instead transmit the hashed and encrypted RFID identifiers by storing in a hashed RFID database 216 accessible over a network 218 and cross-referenced by container RFID identifier 212. Instead of using the hashed and encrypted RFID identifiers 214 from container 202, the recipient reads the container RFID identifier 212 and looks up the value in hashed RFID database 216. Access to hashed RFID database 216 requires connectivity to network 218 and secure access to hashed and encrypted RFID identifiers in hashed RFID database 216.

It is contemplated that this process can be repeated for larger containers holding multiple containers 202 or essentially containers within containers. Accordingly, container RFID identifier 212 is combined with other container RFID identifiers from groups of containers (not shown) organized together or stored in much larger containers. For example, these larger containers containing multiple smaller containers can be standardized containers typically used on container ships, trucks and trains. The hash and encryption operation previously described is performed on the one or more RFID identifiers from container RFID tags of the containers and transmitted along with the containers or cargo in a manner consistent with the previous description. A hierarchical arrangement of containers and items can be created using implementations of the present invention to ensure authenticity of the items at each of the different levels of the hierarchy. This hierarchical organization of authentication makes it easier to identify where and potentially who is introducing counterfeit items and RFID tags.

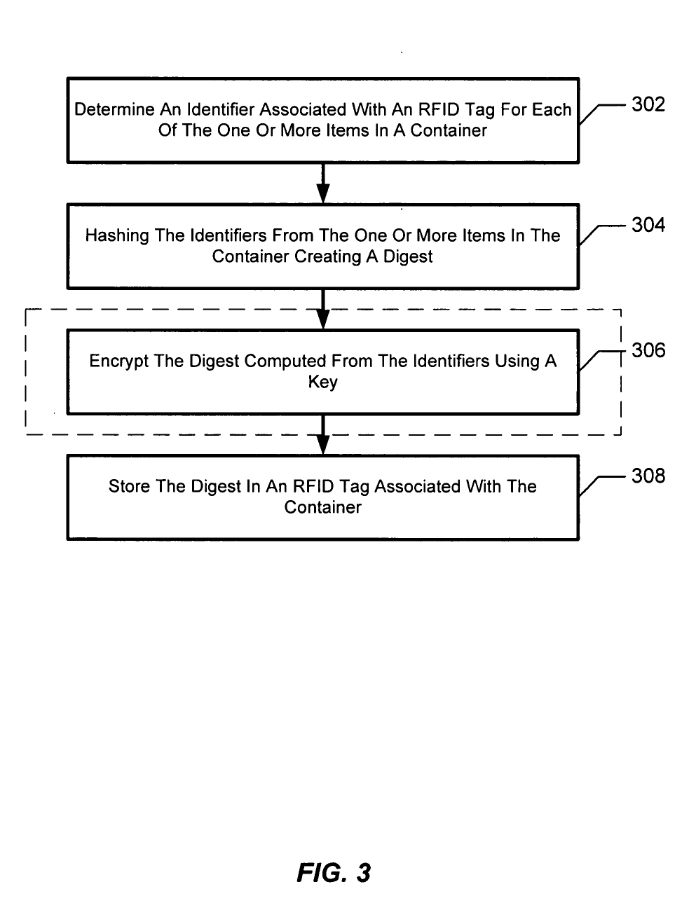

FIG. 3 is a flowchart of the operations associated with hashing and encrypting RFID identifiers (referred to also as identifiers) in accordance with one implementation of the present invention. This first set of operations is typically performed by a party sending one or more items in a container as a result of a sale of goods or as an intermediary forwarding the items along a shipping route. In one implementation, each item has an RFID tag as they are being shipped in an associated container. For example, the items being sent can be pills and many pills can be placed in a medicine vial type of container for holding the pills. It is possible that multiple medicine vials can be placed inside larger containers including boxes and crates of medicine vials.

Initially, an RFID reader device determines the identifier associated with an RFID tag for each of the one or more items in a container (302). The RFID reader device can be a handheld scanner device or a more automated or robotic device that moves around the container of items until the identifier associated with each item in the container has been read. While the information may not be used immediately, the RFID reader device also reads the RFID tag associated with the container and obtains the container identifier as well.

Implementations of the present invention then hash the identifiers from the one or more items in the container creating a digest (304). As previously mentioned, the hash operation applied is selected from a set of hash operations including: MD4, MD5, SHA, SHA-1 or any other hash operation deemed suitable for the particular situation. The hashing operation typically takes an arbitrary sequence of alpha-numeric characters and produces a predetermined length string or digest that serves as a signature for the group of identifiers associated with the items.

To improve the quality of the authentication operation, implementations of the present invention can optionally also encrypt the digest computed from the identifiers using a key (306). One implementation of the encryption operation uses a shared secret known only by the sender and receiver. Without this key, a counterfeiter cannot introduce counterfeit items and RFID tags into the container without being detected. For example, the counterfeiter might be able to hash the combination of identifiers but will not be able to encrypt the values correctly. Alternatively, a public key-private key encryption method can be implemented instead of requiring the sender and receiver to exchange a shared secret key. Public key-private key encryption greatly simplifies the encryption portion of this operation as well as help keep the key and encrypted information more secure from potential counterfeiters. The hashing and optional encryption operations can be performed as separate operations or together using HMAC-MD4, HMAC-MD5, HMAC-SHA, HMAC-SHA-1 or other similar type functions.

Next, the digest is stored in an RFID tag associated with the container (308). The party sending the items uses an RFID writer device to store the value of the digest in the RFID tag in the container or alternatively in another location like a secure database accessible over a network. If the digest has been encrypted, the sender stores the encrypted digest rather than a cleartext or unencrypted version of the digest.

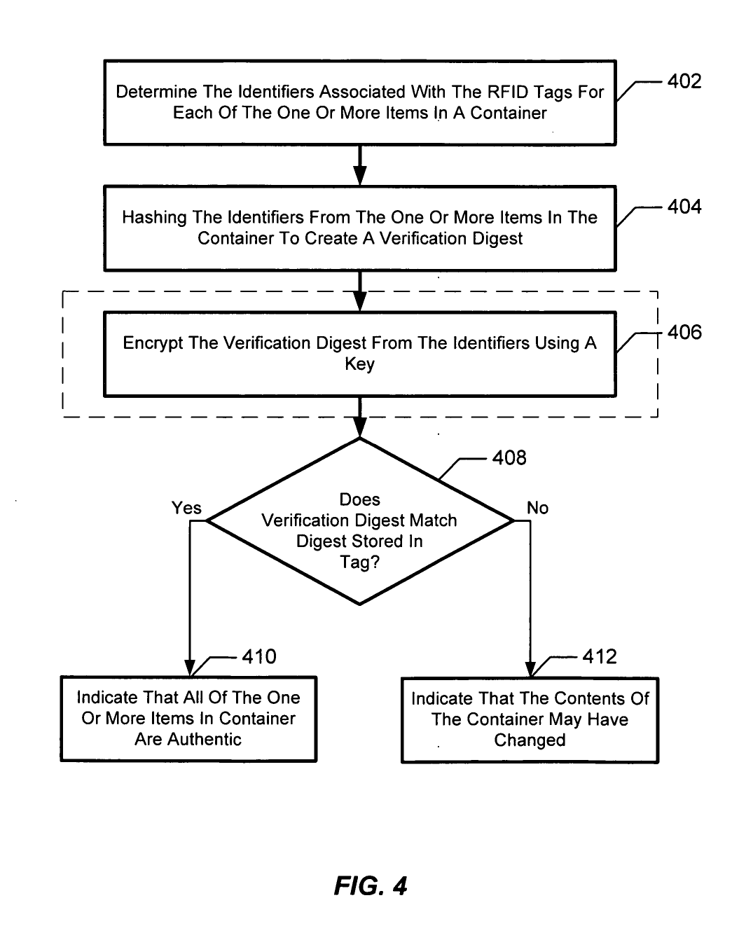

FIG. 4 is another flowchart illustrating the operations associated with authenticating one or more items in accordance with implementations of the present invention. Upon receiving the container of items, an RFID reader device determines the identifiers associated with the RFID tags for each of the one or more items in a container (402). The RFID reader device can be a robotic or automated device that scans the container and detects the RFID tags associated with the items inside. Once the identifiers are determined, implementations of the present invention compute a verification digest using the identifiers from the one or more items in the container (404). This operation involves combining the identifiers in a predetermined manner and then hashing the results into a digest value.

If the digest being transmitted has been encrypted then the verification digest is also encrypted using a key (406). Because encryption is an optional step for improved authentication, the verification digest can also be used in either a cleartext or unencrypted format depending on whether the party sending the digest value selected not to encrypt the digest stored in the RFID tag. An alternate implementation of the present invention uses the key to decrypt the encrypted digest value stored in the RFID tag of the container instead of encrypting the verification digest.

Next, one implementation of the present invention compares the verification digest with the digest stored in the RFID tag to determine if there is a match (408). Alternate implementations of the present invention perform the comparison operation using the encrypted verification digest and encrypted digest stored in the RFID tag. Once again, the hashing and encryption operations can be performed as separate operations or together using HMAC-MD4, HMAC-MD5, HMAC-SHA, HMAC-SHA-1 or other type function. As previously mentioned, if encryption is incorporated then the decryption operation can be performed by way of a shared private key or through the use of a public-key encryption scheme such as PGP.

As a result of the comparison, there are two possible results. If the verification digest matches the digest stored in the tag (408) then an indication is provided that all of the one or more items in the container are authentic (410). A match between the digest values implies that the same RFID tags and items sent were the same as the RFID tags and items received. Alternatively, if the verification digest does not match the digest stored in the tag then an indication is provided that the contents of the container may have changed and one or more items in the container may not be authentic (412). For example, if even one counterfeit item and/or identifier is in the container then the verification digest will not match. Other reasons for the verification digest mismatch include: 1) at least one item and tag in the container has been removed, 2) at least one item and corresponding tag cannot be read or is broken, or 3) one or more authentic or counterfeit items and corresponding RFID tags have been added to the container since the digest values were created.

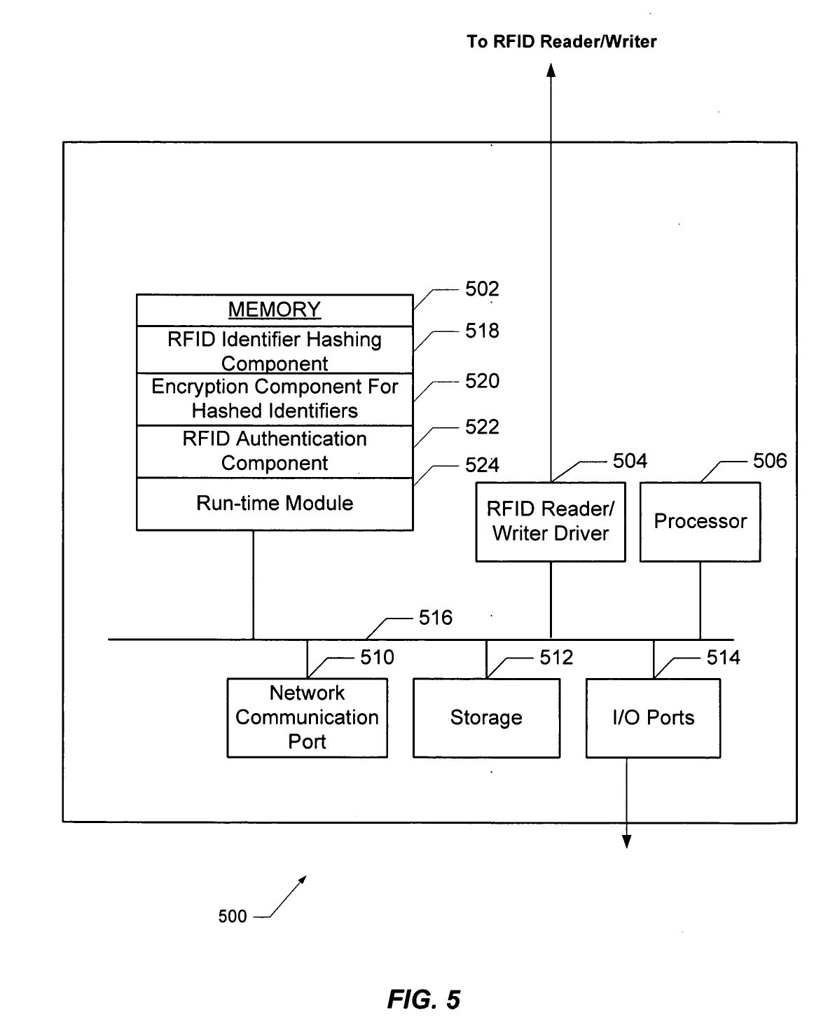

FIG. 5 is a schematic diagram of a RFID authentication system 500, hereinafter system 500, and components used in accordance with one implementation of the present invention. System 500 includes a memory 502 to hold executing programs (typically random access memory (RAM) or read-only memory (ROM) such as a flash RAM), an RFID reader/writer driver 504 capable of driving an RFID reader/writer for reading data from and writing data to RFID tags, a processor 506, a network communication port 510 for data communication, a storage 512, and input/output (I/O) ports 514 operatively coupled together over an interconnect 516. The RFID reader/writer obtains identifiers from RFID tags and processes them on system 500. System 500 can be preprogrammed, in ROM, for example, using field-programmable gate array (FPGA) technology or it can be programmed (and reprogrammed) by loading a program from another source (for example, from a floppy disk, a CD-ROM, or another computer). Also, system 500 can be implemented using customized application specific integrated circuits (ASICs).

In one implementation, memory 502 includes an RFID identifier hashing component 518, an encryption component for hashed identifiers 520, RFID authentication component 522 and run-time module 524 that manages the resources associated with system 500. In operation, RFID identifier hashing component 518 performs a hashing operation on one or more identifiers to produce a digest. For example, the hashing operation can be selected from one or more hash methods including: MD4, MD5, SHA and SHA-1. Encryption component for hashed identifiers 520 then encrypts or decrypts the digest values in accordance with implementations of the present invention. The results of these operations are then processed by RFID authentication component 522 and an indication is provided that the items in the container are either authentic or counterfeit.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. For example, identifiers are described as from RFID tags however the identifiers could alternatively be associated with bar codes instead of RFID tags or a mixture of bar codes and RFID tags. Instead of hashing identifiers only from RFID tags, implementations of the present invention can also hash identifiers from bar code tags or a combination of identifiers from bar code tags and RFID tags. The identifiers from the bar code tags and RFID tags would then be hashed, encrypted, decrypted or otherwise processed together in accordance with implementations of the present invention. Further, implementations of the present invention can also be applied for use with identifiers embedded in microprocessors or in microprocessors having integrated RFID tags and thus should not be construed as being limited only for use with conventional RFID tag technology. Accordingly, the invention is not limited to the above-described implementations, but instead is defined by the appended claims in light of their full scope of equivalents.

What is claimed is:

1. An authentication method for tagged items, comprising:
determining an identifier associated with a tag for each of one or more items in a container; and
hashing the identifiers from the one or more items in the container creating a digest.

2. The method of claim 1 wherein the tag is selected from a set of tags including: bar code tags and RFID tags.

3. The method of claim 1 further comprising:
encrypting the digest hashed from the identifiers using a key.

4. The method of claim 2 further comprising storing the digest in an RFID tag associated with the container.

5. The method of claim 1 further comprising storing the digest into a database cross referenced by an identifier from a tag associated with the container.

6. The method of claim 1 wherein hashing the digest is performed in accordance with a message authentication code selected from a set of cryptographic hash operations including: MD4, MD5, SHA, and SHA-1.

7. The method of claim 3 wherein hashing the digest and encrypting the digest are performed in accordance with a hashed message authentication code selected from a set of hashed message authentication code operations including: HMAC-MD4, HMAC-MD5, HMAC-SHA, and HMAC-SHA1.

8. The method of claim 1 wherein the one or more items in the container are used in conjunction with an industry selected from a set of industries including: drug delivery, medical tools, medical devices, automotive tools, automotive parts, automobiles, entertainment, sports, luxury and computers.

9. The method of claim 8 wherein the one or more items associated with the drug delivery industry are selected from a set of items including: pills, inhalers, syringes, injectable materials, transdermal patches and subcutaneous drug implants.

10. The method of claim 8 wherein the one or more items associated with the entertainment industry is selected from a set including: electronics equipment, compact discs (CD), digital video discs (DVD) and CD-ROM.

11. The method of claim 8 wherein the one or more items associated with the sports industry is selected from a set including: golf clubs, golf balls, tennis rackets and sport shoes.

12. The method of claim 8 wherein the one or more items associated with the luxury industry is selected from a set including: purses, wallets, handbags and shoes.

13. An authentication method for tagged items, comprising:
determining an identifier associated with a tag for each of the one or more items in a container;
hashing the identifiers from the one or more items in the container to create a verification digest;
determining if the verification digest matches a digest of the identifiers previously hashed; and
indicating that the contents of the container may have changed in response to the match determination.

14. The method of claim 13 wherein the tag is selected from a set of tags including: bar code tags and RFID tags.

15. The method of claim 13 further comprising:
encrypting the verification digest hashed from the identifiers using a key when the digest of identifiers previously hashed are also encrypted.

16. The method of claim 13 further comprising:
decrypting the digest of identifiers previously hashed using a key.

17. The method of claim 14 further comprising retrieving from an RFID tag associated with the container the digest of identifiers previously hashed.

18. The method of claim 13 further comprising storing the digest into a database cross referenced by an identifier from a tag associated with the container.

19. The method of claim 13 wherein hashing the verification digest is performed in accordance with a message authentication code selected from a set of cryptographic hash operations including: MD4, MD5, SHA, and SHA-1.

20. The method of claim 14 wherein hashing the verification digest and encrypting the digest are performed in accordance with a hashed message authentication code selected from a set of hashed message authentication code operations including: HMAC-MD4, HMAC-MD5, HMAC-SHA, and HMAC-SHA1.

21. The method of claim 13 wherein the one or more items in the container are used in conjunction with an industry selected from a set of industries including: drug delivery, medical tools, medical devices, automotive tools, automotive parts, automobiles, entertainment, sports, luxury and computers.

22. An authentication apparatus for tagged items, comprising:
a processor capable of executing instructions;
a memory capable of storing instruction when executed cause the processor to determine an identifier associated with a tag for each of one or more items in a container and hash the identifiers from the one or more items in the container creating a digest.

23. The apparatus of claim 22 wherein the tag is selected from a set of tags including: bar code tags and RFID tags.

24. The apparatus of claim 22 further comprising instructions when executed that,
encrypt the digest hashed from the identifiers using a key.

25. The apparatus of claim 22 further comprising storing the digest in an RFID tag associated with the container.

26. The apparatus of claim 22 wherein the instructions hash the digest in accordance with a message authentication code selected from a set of cryptographic hash operations including: MD4, MD5, SHA, and SHA-1.

27. The apparatus of claim 24 wherein the instructions hash and encrypt the digest in accordance with a hashed message authentication code selected from a set of hashed message authentication code operations including: HMAC-MD4, HMAC-MD5, HMAC-SHA, and HMAC-SHA1.

28. An authentication apparatus for tagged items, comprising:
a processor capable of executing instructions;
a memory capable of storing instructions when executed cause the processor to determine an identifier associated with a tag for each of the one or more items in a container, hash the identifiers from the one or more items in the container to create a verification digest, determine if the verification digest matches a digest of the identifiers previously hashed and indicate that the contents of the container may have changed in response to the match determination.

29. The apparatus of claim 28 wherein the tag is selected from a set of tags including: bar code tags and RFID tags.

30. The apparatus of claim 28 wherein the instructions hash the verification digest in accordance with a message authentication code selected from a set of cryptographic hash operations including: MD4, MD5, SHA, and SHA-1.

31. The apparatus of claim 28 wherein the instructions hash and encrypt the verification digest in accordance with a hashed message authentication code selected from a set of hashed message authentication code operations including: HMAC-MD4, HMAC-MD5, HMAC-SHA, and HMAC-SHA1.

32. A computer program product for authenticating tagged items, tangibly stored on a computer-readable medium, comprising instructions operable to cause a programmable processor to:
determine an identifier associated with a tag for each of one or more items in a container; and
hash the identifiers from the one or more items in the container creating a digest.

33. A computer program product for authenticating tagged items, tangibly stored on a computer-readable medium, comprising instructions operable to cause a programmable processor to:
determine an identifier associated with a tag for each of the one or more items in a container;
hash the identifiers from the one or more items in the container to create a verification digest;
determine if the verification digest matches a digest of the identifiers previously hashed; and
indicate that the contents of the container may have changed in response to the match determination.

34. The computer program product of claim 33 wherein the tag is selected from a set of tags including: bar code tags and RFID tags.

35. An authentication apparatus for tagged items, comprising:
means for determining an identifier associated with a tag for each of one or more items in a container; and
means for hashing the identifiers from the one or more items in the container creating a digest.

36. An authentication apparatus for tagged items, comprising:
means for determining an identifier associated with a tag for each of the one or more items in a container;
means for hashing the identifiers from the one or more items in the container to create a verification digest;
means for determining if the verification digest matches a digest of the identifiers previously hashed; and
means for indicating that the contents of the container may have changed in response to the match determination.
